(19) United States
(12) Patent Application Publication
(10) Pub. No.: US 2009/0011209 A1
(43) Pub. Date: Jan. 8, 2009

(54) NONWOVEN BASED ON THERMOPLASTIC POLYURETHANE

(75) Inventors: Rolf Steinberger, Bissendorf (DE); Hauke Malz, Diepholz (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/281,635

(22) PCT Filed: Feb. 28, 2007
(86) PCT No.: PCT/EP2007/051864

§ 371 Date: Sep. 4, 2008

(30) Foreign Application Priority Data
Mar. 6, 2006 (EP) 06110709.0

(51) Int. Cl. B32B 27/40; D04H 13/00; B32B 5/02; B29C 47/00

(52) U.S. Cl. 428/219; 442/327; 428/220; 264/176.1

(57) ABSTRACT

A nonwoven is based on a thermoplastic polyurethane having a crystallization temperature between 130° C. and 220° C. and being based on an aliphatic isocyanate.

This invention concerns nonwoven based on thermoplastic polyurethane having a crystallization temperature between 130° C. and 220° C., preferably between 140° C. and 200° C. and more preferably between 150° C. and 200° C. and being based on aliphatic isocyanates. This invention also concerns nonwoven based on a thermoplastic polyurethane obtainable by reaction of (a) isocyanates with (b1) polyester diols having a melting point of more than 150° C., (b2) polyether diols and/or polyester diols each having a melting point of less than 150° C. and a molecular weight of 501 to 8000 g/mol and also (c) diols having a molecular weight of 62 g/mol to 500 g/mol, the molar ratio of the diols (c) having a molecular weight of 62 g/mol to 500 g/mol to component (b2) preferably being between 0.1 to 0.01. This invention further concerns nonwoven based on a thermoplastic polyurethane obtainable by
(i) reacting a thermoplastic polyester with a diol (c) and then
(ii) reacting the reaction product from (i) comprising (b1) polyester diol having a melting point of more than 150° C. and also if appropriate (c) diol together with (b2) polyether diols and/or polyester diols each having a melting point of less than 150° C. and a molecular weight of 501 to 8000 g/mol and also if appropriate further (c) diols having a molecular weight of 62 to 500 g/mol with (a) isocyanate if appropriate in the presence of (d) catalysts and/or (e) auxiliaries.

The present invention also concerns processes for producing such nonwovens.

Nonwovens are non-woven textile structures produced by adhering or bonding or adhering and bonding fibers together by mechanical, chemical, thermal or solvent-engineering methods or any combination thereof. Polymeric nonwovens are mainly produced in continuous processes. The meltblown and spunbond processes may be mentioned here in particular. In these processes, the polymer is melted in an extruder and pumped to a spinning manifold. State of the art nonwoven processes operate at high throughputs and utilize spinning manifolds up to 5 m in width and are capable of continuous production of the nonwovens.

The production of nonwovens by the meltblown and spunbond processes utilizes polypropylene and polyester in the main. However, nonwovens produced from these plastics are not elastic. This is why there have been efforts in recent years to use thermoplastic polyurethanes (hereinafter also referred to as TPUs) to make nonwovens. Thermoplastic polyurethanes are polyurethanes which, when repeatedly heated and cooled in the temperature range typical for processing and using the material of construction, remain thermoplastic. Thermoplastic in relation to a polyurethane describes the polyurethane's property of, in a temperature range between 150° C. and 300° C. typical for the polyurethane, repeatedly softening when hot and hardening when cold, and, in the softened state, repeatedly being moldable into intermediate or final articles by flowing as a molded, extruded or formed part. Nonwovens based on TPUs are notable for very high elasticity, good recovery, low retained extensibility and tensile strength.

Aromatic thermoplastic polyurethanes are TPUs based on an aromatic isocyanate, for example 4,4′ MDI. Aliphatic TPUs are TPUs based on aliphatic isocyanates, for example 1,6 HDI.

Nonwovens go into many different applications such as the hygiene sector, for example diapers and disposable flannels, but also into industrial fields such as, for example, filters, into applications in medicine and into applications in structural and civil engineering, such as geotextiles and roofing underlayments.

A very important criterion for nonwovens specifically in the hygiene sector, for textiles and in the medical sector is their lightfastness, since consumers equate a yellowed nonwoven with “unhygienic” or “low quality”, whereas they associate a white nonwoven with “hygienic and high quality”. Lightfastness is the ability of materials of any kind (textiles, prints, plastics, ceramics, etc.) and in all processing stages to resist color changes due to direct exposure to daylight without direct exposure to weathering.

Owing to their differences in chemical construction, plastics offer different stabilities to UV light and thermal damage or to damage due to environmental influences in general. It would nonetheless be desirable to make the area of application of all plastics as broad as possible, i.e., to increase the stability of the plastic to environmentally based damage, for example due to heat, sunlight or UV light.

It is common general knowledge to protect plastics with stabilizers. For example, plastics can be protected against UV damage with a mixture consisting of an antioxidant (AO) and a Hindered Amine Light Stabilizer (HALS), or with a mixture consisting of a UV absorber and a phenolic antioxidant, or with a mixture consisting of a phenolic antioxidant, a HALS and a UV absorber. Owing to the distinct improvements in properties achieved for plastics including stabilizing additives, an inestimably large number of different stabilizers and stabilizer combinations is now commercially available. Examples of such compounds are given in Plastics Additive Handbook, 5th Edition, H. Zweifel, ed., Hanser Publishers, Munich, 2001 ([1]), pages 98-136.

Examples of a good stabilization of TPU with various stabilizers in combination are given in WO 03/031506.

However, the lightfastness of an otherwise very effectively stabilized aromatic TPU is often deemed insufficient. For this reason, the development of aliphatic TPUs has been accelerated in recent years. Their chemical structure is such that aliphatic TPUs do not form any chromophores therefore they do not discolor. Aliphatic TPUs are therefore more and more widely used in automotive construction in particular.

However, surprisingly, aliphatic TPUs do not make high-quality nonwovens, since very high TPU temperatures of up to 240° C. and hot air temperatures of up to 270° C. have to be employed in processing. Consequently, the TPU filament does not crystallize on its way from the die to the collector belt. The still deformable fibers stick together and the nonwoven acquires an unpleasant plasticky hand, which is perceived as non-textile. In addition, the mechanical performance of such a nonwoven is inadequate.

The present invention has for its object to produce a lightfast TPU nonwoven which has a pleasant textile hand, is efficiently processible and possesses good mechanical properties, in particular a good breaking extension.

We have found that these objects are achieved by the nonwovens defined at the beginning.

The nonwovens of the present invention are notable in that the thermoplastic polyurethanes used have rapid solidifying characteristics. This means that, as the molten yarn cools, the TPU undergoes a rapid crystallization at high temperatures, which leads to early stabilization of the fiber. Consequently, the product is processible on conventional equipment to obtain a nonwoven having a textile hand. Textile hand means in this context that the haptics of the nonwoven correspond to those of a woven or knit textile. The opposite of a textile hand would be, for example, a plasticky hand whereby the nonwoven would feel like a plastics film.

The particularly preferred thermoplastic polyurethanes exhibit optically clear, single-phase melts which solidify rapidly and, as a consequence of the partly crystalline polyester hard phase, form slightly opaque to nontransparent white moldings.

Determining the crystallization temperature of the thermoplastic polyurethanes of the present invention is common general knowledge and is preferably effected by DSC (Dynamic Scanning Calorimetry) using a Perkin Elmer DSC 7, the thermoplastic polyurethane being treated according to the following temperature program:

1. hold at 25° C. for 0.1 min
2. heat from 25° C. to 100° C. at 40 K/min
3. hold at 100° C. for 10 min
4. cool from 100° C. to 80° C. at 20 K/min
5. hold at −80° C. for 2 min
6. heat from −80° C. to 230° C. at 20 K/min
7. hold at 230° C. for 1 min
8. cool from 230° C. to 80° C. at 20 K/min,
and the crystallization temperature is deemed to be that temperature at which the exothermic heat flux of the sample has a maximum during cooling.

A nonwoven is a layer, web and/or lap of directionally aligned or randomly disposed fibers, consolidated by friction and/or cohesion and/or adhesion. Nonwovens are also known as non-wovens.

Paper or articles of manufacture which have been woven, knit, tufted, stitch bonded through incorporation of binding yarns or filaments, or felted by a wet-fulling operation are preferably not treated as nonwovens for the purposes of this invention.

In one preferred embodiment, a material is to be deemed a nonwoven for the purposes of this invention when more than 50%, and in particular 60% to 90% of the mass of its fibrous constituent consists of fibers having a length to diameter ratio of more than 300 and in particular of more than 500.

Preference is given to nonwovens wherein the thermoplastic polyurethane has a hardness between 50 Shore A and 80 Shore D, more preferably between 60 Shore A and 60 Shore D and especially between 60 Shore A and 95 Shore A.

in one preferred embodiment, the diameters of the individual fibers of the nonwoven are in the range from 50 μm to 0.1 μm, preferably in the range from 10 μm to 0.5 μm and especially in the range from 7 μm to 0.5 μm.

In one preferred embodiment, the thickness of the nonwovens is in the range from 0.01 to 5 millimeters (mm), more preferably in the range from 0.1 to 2 mm and even more preferably in the range from 0.15 to 1.5 mm, measured to ISO 9073-2.

In one preferred embodiment, the mass per unit area of the nonwovens is in the range from 5 to 500 g/m², more preferably in the range from 10 to 250 g/m², and even more preferably in the range of 15-150 g/m², measured to ISO 9073-1.

The nonwoven may additionally be mechanically consolidated. Mechanical consolidation may take the form of one-sided or both-sided mechanical consolidation; two-sided mechanical consolidation is preferred.

In addition to the afore-described mechanical consolidation, the nonwoven may further be thermally consolidated. Thermal consolidation may be effected for example by subjecting the nonwoven to a treatment with hot air or by calendering the nonwoven. Calendering the nonwoven is preferred.

In one preferred embodiment. the nonwoven used has a machine direction breaking extension between 20% and 2000%, preferably between 100% and 1000% and especially between 200% and 1000%, measured to DIN EN 12127.

The nonwoven used is based on, i.e., is made using, thermoplastic polyurethane. This is to be understood as meaning that the nonwoven used comprises thermoplastic polyurethane, preferably as an essential constituent. One preferred embodiment utilizes a nonwoven comprising thermoplastic polyurethane in an amount of 60% by weight to 100% by weight, more preferably of more than 80% by weight and especially more than 97% by weight, based on the total weight of the nonwoven.

As well as thermoplastic polyurethane, the nonwoven used may further comprise other polymers or auxiliaries, examples being polypropylene, polyethylene and/or polystyrene and/or copolymers of polystyrene such as styrene-acrylonitrile copolymers.

Thermoplastic polyurethanes, also referred to herein as TPUs, and processes for their production are common general knowledge. In general, TPUs are produced by reaction of (a) isocyanates with (b) isocyanate-reactive compounds, typically having a molecular weight (M_{w}) in the range from 500 to 10 000, preferably in the range from 500 to 5000 and more preferably in the range from 800 to 3000, and (c) chain extenders having a molecular weight in the range from 50 to 499 if appropriate in the presence of (d) catalysts and/or (e) customary additives.

In what follows, the starting components of the preferred polyurethanes and processes for producing the preferred polyurethanes are described by way of example. The components (a), (b), (c) and also if appropriate (d) and/or (e) customarily used in the preparation of polyurethanes will now be described by way of example:

Useful aliphatic isocyanates (a) include commonly known isocyanates, preferably diisocyanates, examples being tri-, tetra-, penta-, hexa-, hepta- and/or octamethylene diisocyanate, 2-methylpentamethylene 1,5-diisocyanate, 2-ethylbutylene 1,4-diisocyanate, 1,5-pentamethylene diisocyanate, 1,4-butylene diisocyanate, 1-isocyanato-3,3,5-trimethyl-5-isocyanato-methyl-cyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or 2,6-cyclohexane diisocyanate and/or 4,4′-, 2,4′- and 2,2′-dicyclohexylmethane diisocyanate, more preferably 1-isocyanato-3,3,5-trimethyl-5-isocyanatomethylcyclohexane (isophorone diisocyanate, IPDI) and/or hexamethylene diisocyanate (HDI), in particular hexamethylene diisocyanate.

Useful isocyanate-reactive compounds (b) include commonly known isocyanate-reactive compounds, examples being polyesterols, polyetherols and/or polycarbonate diols, which are customarily also subsumed under the term “polyols”, having molecular weights between 500 and 8000, preferably 600 to 6000, especially 800 to less than 3000, and preferably an average functionality of 1.8 to 2.3, preferably 1.9 to 2.2 and especially 2 with regard to isocyanates.

Useful polyetherols further include so-called low unsaturation polyetherols. Low unsaturation polyetherols for the purposes of this invention are in particular polyether alcohols containing less than 0.02 meg/g and preferably less than 0.01 meg/g of unsaturated compounds.

Such polyether alcohols are usually prepared by addition of alkylene oxides, in particular ethylene oxide, propylene oxide and mixtures thereof, onto the above-described diols or triols in the presence of high activity catalysts. Examples of such high activity catalysts are cesium hydroxide and multi metal cyanide catalysts, also known as DMC catalysts. Zinc hexacyanocobaltate is a frequently employed DMC catalyst. A DMC catalyst can be left in the polyether alcohol after the reaction, but typically it is removed, for example by sedimentation or filtration.

It is further possible to use polybutadiene diols having a molar mass of 500-10 000 g/mol preferably 1000-5000 g/mol, especially 2000-3000 g/mol. TPUs prepared using these polyols can be radiation crosslinked after thermoplastic processing. This leads to a better burn-off behavior.

Mixtures of various polyols can be used instead of just one polyol.

Useful chain extenders (c) include commonly known aliphatic, araliphatic, aromatic and/or cycloaliphatic compounds having a molecular weight in the range from 50 to 499, preferably 2-functional compounds, examples being diamines and/or alkane diols having 2 to 10 carbon atoms in the alkylene radical, in particular 1,3-propanediol, 1,4-butanediol, 1,6-hexanediol and/or di-, tri-, tetra-, penta-, hexa-, hepta-, octa-, nona- and/or decaalkylene glycols having 3 to 8 carbon atoms, preferably the corresponding oligo- and/or polypropylene glycols, including mixtures of chain extenders.

Components a) to c) are more preferably difunctional compounds, i.e., diisocyanates (a), difunctional polyols, preferably polyetherols (b) and difunctional chain extenders, preferably diols.

Useful catalysts (d), which speed in particular the reaction between the NCO groups of the diisocyanates (a) and the hydroxyl groups of the building block components (b) and (c), are customary tertiary amines known in the prior art, for example triethylamine, dimethylcyclohexylamine, N-methylmorpholine, N,N′-dimethylpiperazine, 2-(dimethylaminoethoxy)ethanol, diazabicyclo-(2,2,2)-octane and the like, and also in particular organic metal compounds such as titanic esters, iron compounds such as for example iron(III) acetylacetonate, tin compounds, examples being tin diacetate, tin dioctoate, tin dilaurate or the tin dialkyl salts of aliphatic carboxylic acids such as dibutyltin diacetate, dibutyltin dilaurate or the like. The catalysts are typically used in amounts of 0.0001 to 0.1 part by weight per 100 parts by weight of polyhydroxy compound (b).

As well as catalysts (d), customary auxiliaries and/or additives (e) can also be added to the building block components (a) to (c). There may be mentioned for example blowing agents, surface-active substances, nucleators, gliding and demolding aids, dyes and pigments, antioxidants, for example against hydrolysis, light, heat or discoloration, inorganic and/or organic fillers, flame retardants, reinforcing agents and plasticizers, metal deactivators. In one preferred embodiment, component (e) also includes hydrolysis stabilizers such as for example polymeric and low molecular weight carbodiimides. It is particularly preferable for melamine cyanurate, which acts as a flame retardant, to be present in the thermoplastic polyurethane in the materials of the present invention. Melamine cyanurate is preferably employed in an amount between 0.1% and 60% by weight, more preferably between 5% and 40% by weight and especially between 15% and 25% by weight, all based on the total weight of the TPU. Preferably, the thermoplastic polyurethane comprises triazole and/or triazole derivative and antioxidants in an amount of 0.1% to 5% by weight based on the total weight of the thermoplastic polyurethane. Useful antioxidants are generally substances that inhibit or prevent unwanted oxidative processes in the plastic to be protected. In general, antioxidants are commercially available. Examples of antioxidants are sterically hindered phenols, aromatic amines, thio synergists, organophosphorus compounds of trivalent phosphorus and Hindered Amine Light Stabilizers. Examples of sterically hindered phenols are to be found in Plastics Additive Handbook, 5th edition, H. Zweifel, ed, Hanser Publishers, Munich, 2001 ([1]), pages 98-107 and pages 116-121. Examples of aromatic amines are to be found in [1] pages 107-108. Examples of thio synergists are given in [1], pages 104-105 and pages 112-113. Examples of phosphites are to be found in [1], pages 109-112. Examples of hindered amine light stabilizers are given in [1], pages 123-136. Phenolic antioxidants are preferred for use. In one preferred embodiment, the antioxidants, in particular the phenolic antioxidants, have a molar mass of greater than 350 g/mol, more preferably greater than 700 g/mol and a maximum molar mass <10 000 g/mol preferably <3000 g/mol. They further preferably have a melting point of less than 180° C. It is further preferable to use antioxidants that are amorphous or liquid.

As well as the specified components a), b) and c) and if appropriate d) and e), chain regulators, customarily having a molecular weight of 31 to 3000, can also be used. Such chain regulators are compounds which have only one isocyanate-reactive functional group, examples being monofunctional alcohols, monofunctional amines and/or monofunctional polyols. Such chain regulators make it possible to adjust flow behavior in the case of TPUs in particular to specific values. Chain regulators can be used in general in an amount of 0 to 5 parts and preferably 0.1 to 1 part by weight based on 100 parts by weight of component b), and by definition come within component (c).

To adjust the hardness of TPUs, the building block components (b) and (c) can be varied within relatively wide molar ratios. Useful are molar ratios of component (b) to total of chain extenders (c) in the range from 10:1 to 1:10 and in particular in the range from 1:1 to 1:4, TPU hardness increasing with increasing (c) content.

The thermoplastic polyurethane preferably has a viscosity number (measured in phenol/chlorobenzene) of at least 100 cm³/g, preferably between 100 cm³/g and 1000 cm³/g, more preferably between 200 cm³/g and 600 cm³/g and especially between 250 cm³/g and 500 cm³/g.

The nonwovens of the present invention are preferably produced using TPUs described in WO 03/014179, provided they are based on aliphatic isocyanates. These particularly preferred TPUs, which will be exhaustively described hereinbelow, have the advantage that the thermoplastic polyurethanes used have rapid solidifying characteristics, i.e., a very good crystallization at high temperatures of the melt. This makes it possible to process the thermoplastic polyurethanes on conventional equipment to obtain a nonwoven having a textile hand. Textile hand means in this context that the haptics of the nonwoven correspond to those of a woven or knit textile. The opposite of a textile hand would be, for example, a plasticky hand whereby the nonwoven would feel like a plastics film.

These particularly preferred TPUs are preferably obtainable by reaction of (a) isocyanates with (b1) polyester diols having a melting point of about 150° C., (b2) polyether diols and/or polyester diols each having a melting point of below 150° C. and a melting point of 501 to 8000 g/mol and also (c) diols having a molecular weight of 62 g/mol to 500 g/mol. Preference here is given to thermoplastic polyurethanes wherein the molar ratio of diols (c) having a molecular weight of 62 g/mol to 500 g/mol to component (b2) is less than 0.2 and more preferably in the range from 0.1 to 0.01. Particular preference is given to thermoplastic polyurethanes wherein the polyester diols (b1), which preferably have a molecular weight of 1000 g/mol to 5000 g/mol, have the following structural unit (I):

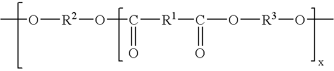

with the following meanings for R1, R2, R3 and X:
R1: carbonaceous scaffold having 2 to 15 carbon atoms, preferably an alkylene group having 2 to 15 carbon atoms and/or a bivalent aromatic radical having 6 to 15 carbon atoms, more preferably having 6 to 12 carbon atoms
R2: straight or branched alkylene group having 2 to 8 carbon atoms, preferably 2 to 6, and more preferably 2 to 4 carbon atoms, especially —CH₂—CH₂— and/or —CH₂—CH₂—CH₂—CH₂—,
R3: straight or branched alkylene group having 2 to 8 carbon atoms, preferably 2 to 6, and more preferably 2 to 4 carbon atoms, especially —CH₂—CH₂— and/or —CH₂—CH₂—CH₂—CH₂—,
X: an integer from 5 to 30. The above preferred melting point and/or the preferred molecular weight are based in this preferred embodiment on the depicted structural unit (I).

“Melting point” herein is to be understood as referring to the maximum of the melting peak of a heating curve measured using a commercially available DSC instrument (for example a DSC 7 from Perkin-Elmer).

The molecular weights reported herein are the number average molecular weights, in [g/mol].

These particularly preferred thermoplastic polyurethanes may preferably be prepared by reacting in a first step (i) a preferably high molecular weight, preferably partly crystalline, thermoplastic polyester with a diol (c) and then in a second reaction (ii) reacting the reaction product from (i) comprising (b1) polyester diol having a melting point of more than 150° C. and also if appropriate (c) diol together with (b2) polyether diols and/or polyester diols each having a melting point of less than 150° C. and a molecular weight of 501 to 8000 g/mol and also if appropriate further (c) diols having a molecular weight of 62 to 500 g/mol with (a) isocyanate if appropriate in the presence of (d) catalysts and/or (e) auxiliaries.

For the reaction (ii), the molar ratio of the diols (c) having a molecular weight of 62 g/mol to 500 g/mol to component (b2) is preferably less than 0.2 and more preferably in the range from 0.1 to 0.01.

Whereas step (i) provides the hard phases for the end product through the polyester used in step (i), the soft phases are constructed through the use of component (b2) in step (ii). The preferred technical teaching is that polyesters having a pronounced, efficiently crystallizing hard phase structure are preferentially melted in a reaction extruder and initially degraded with a low molecular weight diol to form shorter polyesters having free hydroxyl end groups. The originally high crystallization tendency of the polyester is preserved in the process and can subsequently be utilized to obtain, in a rapidly proceeding reaction, TPUs having the advantageous properties, viz high tensile strength values, low abrasion values and, owing to the high and narrow melting range, high heat distortion resistances and low pressure deformation residuals. The preferred process thus has preferably high molecular weight, partly crystalline, thermoplastic polyesters degraded with low molecular weight diols (c) under suitable conditions within a short reaction time to fast-crystallizing polyester diols (b1), which in turn are then incorporated with other polyester diols and/or polyether diols and diisocyanates in high molecular weight polymer chains.

The thermoplastic polyester used, i.e., before reaction (i) with diol (c), preferably has a molecular weight of 15 000 g/mol to 40 000 g/mol and also preferably a melting point of above 160° C. and more preferably in the range from 170° C. to 260° C.

The starting polyester, which is reacted with the diol or diols (c) in step (i) preferably in the molten state more preferably at a temperature of 230° C. to 280° C. preferably for a period of 0.1 min to 4 min, more preferably 0.3 min to 1 min, can be any commonly known, preferably high molecular weight, preferably partly crystalline, thermoplastic polyester, for example in pelletized form. Suitable polyesters are based for example on aliphatic, cycloaliphatic, araliphatic and/or aromatic dicarboxylic acids, for example lactic acid and/or terephthalic acid, and also aliphatic, cycloaliphatic, araliphatic and/or aromatic dialcohols, for example 1,2-ethanediol, 1,4-butanediol and/or 1,6-hexanediol.

Particularly preferred polyesters are: poly-L-lactic acid and/or polyalkylene terephthalate, for example polyethylene terephthalate, polypropylene terephthalate, polybutylene terephthalate, especially polybutylene terephthalate.

Making these esters from the starting materials mentioned is common general knowledge and has been extensively described. Suitable polyesters, moreover, are commercially available.

The thermoplastic polyester is preferably melted at a temperature of 180° C. to 270° C. Reaction (i) with diol (c) is preferably carried out at a temperature of 230° C. to 280° C. and preferably 240° C. to 280° C.

The diol (c) used in step (i) for reaction with the thermoplastic polyester and if appropriate in step (ii) can be any commonly known diol having a molecular weight of 62 to 500 g/mol, for example those mentioned later, examples being ethylene glycol, 1,3-propanediol, 1,4-butanediol, 1,5-pentanediol, 1,6-hexanediol, heptanediol, octanediol, preferably 1,4-butanediol and/or 1,2-ethanediol.

The weight ratio of thermoplastic polyester to diol (c) in step (i) is typically in the range from 100:1.0 to 100:10 and preferably in the range from 100:1.5 to 100:8.0.

The reaction of the thermoplastic polyester with the diol (c) in reaction step (i) is preferably carried out in the presence of customary catalysts, for example those which are described hereinbelow. Preference is given to using catalysts based on metals for this reaction. The reaction in step (i) is preferably carried out in the presence of 0.1% to 2% by weight of catalysts, based on the weight of diol (c). The reaction in the presence of such catalysts is advantageous in order that the reaction may be carried out in the available short residence time in the reactor, for example a reaction extruder.

Useful catalysts for this reaction step (i) include for example tetrabutyl orthotitanate and/or tin(II) dioctoate, preferably tin dioctoate.

The polyester diol (b1) obtained as reaction product from (i) preferably has a molecular weight in the range from 1000 g/mol to 5000 g/mol. The melting point of the polyester diol obtained as reaction product from (i) is preferably in the range from 150° C. to 260° C. and especially in the range from 165 to 245° C.; that is, the reaction product of the thermoplastic polyester with diol (c) in step (i) comprises compounds having the specified melting point, which are used in the subsequent step (ii).

The reaction of the thermoplastic polyester with diol (c) in step (i) causes scissioning of the polymer chain of the polyester by diol (c) through transesterification. The reaction product of the TPU therefore has free hydroxyl end groups and is preferably further processed in the further step (ii) to form the actual product, the TPU.

The conversion of the reaction product from step (i) in step (ii) is preferably effected by addition of a) isocyanate (a) and also (b2) polyether diols and/or polyester diols each having a melting point of less than 150° C. and a molecular weight of 501 to 8000 g/mol and also if appropriate further diols (c) having a molecular weight of 62 to 500, (d) catalysts and/or (e) auxiliaries to the reaction product from (i). The reaction of the reaction product with the isocyanate takes place via the hydroxyl end groups formed in step (i). The reaction in the step (ii) is preferably carried out at a temperature of 190 to 250° C. for a duration of preferably 0.5 to 5 min and more preferably 0.5 to 2 min, preferably in a reaction extruder and more preferably in the same reaction extruder in which step (i) is carried out. For example, the reaction of step (i) can take place in the first barrel section of a customary extrusion reactor and the corresponding reaction of step (i) be carried out at a downstream point, i.e., downstream barrel sections, following the addition of components (a) and (b2). For example, the first 30% to 50% of the length of the reaction extruder can be used for step (i) and the remaining 50% to 70% for step (ii).

The reaction in step (ii) is preferably carried out with an excess of isocyanate groups to isocyanate-reactive groups. The ratio of isocyanate groups to hydroxyl groups in reaction (ii) is preferably in the range from 1:1 to 1.2:1 and more preferably in the range from 1.02:1 to 1.2:1. Reactions (i) and (ii) are preferably carried out in a commonly known reaction extruder.

Such reaction extruders are described by way of example in the company publications of Werner & Pfleiderer or in DE-A 2 302 564.

The method of carrying out the preferred process is preferably such that at least one thermoplastic polyester, for example polybutylene terephthalate, is metered into the first barrel section of a reaction extruder and is melted at temperatures which are preferably between 180° C. to 270° C. and preferably in the range from 240° C. to 270° C., and, in a subsequent barrel section, a diol (c), for example butanediol, and preferably a transesterification catalyst are added, and the polyester is degraded at temperatures between 240° C. to 280° C. by the diol (c) to give polyester oligomers having hydroxyl end groups and molecular weights between 1000 to 5000 g/mol, and, in a subsequent barrel section, isocyanate (a) and (b2) isocyanate-reactive compounds having a molecular weight of 501 to 8000 g/mol and also if appropriate (c) diols having a molecular weight of 62 to 500, (d) catalysts and/or (e) auxiliaries are metered in, and then, at temperatures of 190 to 250° C., the construction to form the preferred thermoplastic polyurethanes is carried out.

In step (ii), it is preferable for no (c) diols having a molecular weight of 62 to 500 to be introduced other than (c) diols present in the reaction product of (i) and having a molecular weight of 62 to 500.

In the region in which the thermoplastic polyester is melted, the reaction extruder preferably has neutral and/or reverse-conveying kneading blocks and reverse-conveying elements, and in the region where the thermoplastic polyester is reacted with the diol it preferably has mixing elements on the screw, and toothed disks, and/or toothed mixing elements in combination with reverse-conveying elements.

Downstream of the reaction extruder, the clear melt is typically fed by a gear pump to an underwater pelletizer, and pelletized.

The fraction of thermoplastic polyester in the end product, i.e., in the thermoplastic polyurethane, is preferably in the range from 5% to 75% by weight. The preferred thermoplastic polyurethanes are more preferably products of the reaction of a mixture comprising 10% to 70% by weight of the reaction product of (i), 10% to 80% by weight of (b2) and 10% to 20% by weight of (a), these weight percentages being based on the total weight of the mixture comprising (a), (b2), (d), (e) and the reaction product from (i).

The preferred thermoplastic polyurethanes preferably have the following structural unit (II):

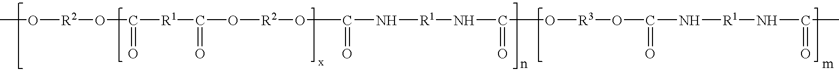

with the following meanings for R1, R2, R3 and X:
R1: carbonaceous scaffold having 2 to 15 carbon atoms, preferably an alkylene group having 2 to 15 carbon atoms and/or an aromatic radical having 6 to 15 carbon atoms,
R2: straight or branched alkylene group having 2 to 8 carbon atoms, preferably 2 to 6 and more preferably 2 to 4 carbon atoms, in particular —CH2-CH2- and/or —CH2-CH2-CH2-CH2-,
R3: a radical resulting from the use of polyether diols and/or polyester diols each having molecular weights between 501 g/mol and 8000 g/mol as (b2) or from the use of alkanediols having 2 to 12 carbon atoms for the reaction with diisocyanates,
X: an integer from 5 to 30,
n, m: an integer from 5 to 20.

The R¹ radical is defined by the isocyanate used, the R² radical by the reaction product of the thermoplastic polyester with the diol (c) in (i) and the R³ radical by the starting components (b2) and if appropriate (c) in the preparation of the TPUs.

The nonwovens comprising thermoplastic polyurethane can typically be produced from above-described thermoplastic polyurethane by the conventional meltblown process or spunbond process. Meltblown processes and spunbond processes are known to those skilled in the art.

The nonwovens which are formed in the processes generally differ in terms of their mechanical properties and their consistency. Nonwovens produced by the spunbond process are particularly stable both horizontally and vertically, but have an open-celled structure.

Nonwovens produced by the meltblown process have a particularly dense network of fibers and hence form a very effective barrier to liquids.

Meltblown nonwovens are preferred.

To produce a TPU nonwoven by the meltblown process, a commercial plant for producing meltblown nonwovens can be used. Such plant is available from Reifenhäuser of Germany for example.

Typically, in a meltblown process, the TPU is melted in an extruder and fed by means of customary ancillaries such as melt pumps or filters to a spinning manifold. Here, the polymer generally flows through nozzles and, at the nozzle exit, is attenuated by an airstream to form a filament. The attenuated filaments are typically laid down on a drum or belt and forwarded.

A preferred embodiment utilizes a single-screw extruder having a compression ratio of 1:2-1:3.5 and particularly preferably 1:2-1:3.

It is preferable to employ in addition a three-zone screw having a length to diameter (L/D) ratio of 25-30. The three zones are preferably equal in length. The three-zone screw preferably has throughout a constant pitch of 0.8-1.2 D and particularly preferably 0.95-1.05 D. The clearance between the screw and the barrel is >0.1 mm, preferably 0.1-0.2 mm.

When a barrier screw is used as extruder screw, it is preferable to employ an overflow gap >1.2 mm.

When the screw is equipped with mixing elements, these mixing elements are preferably not shearing elements.

The nonwoven plant is typically dimensioned such that the residence time of the TPU is as short as possible, i.e., <15 min, preferably <10 min and more preferably <5 min.

The TPU of the present invention is typically processed at temperatures between 180° C. and 250° C. and preferably between 200° C. and 230° C.

The nonwovens of the present invention are used for example as seals in the industrial sector, hygiene products, filters, medical/medicinal products, laminates and textiles, for example as plasters, wound dressings and bandages in the medical sector, as elastic elements in diapers and other hygiene articles, as elastic cuffs in apparel, as inliners in apparel, as backings for films, for example in the manufacture of water vapor permeable membranes, as a laminate for leather, as antislip protector for tablecloths, carpets, as antislip protector for socks, as decorative appliqué in the automotive interior, in textiles and sports shoes, curtains, furniture and the like.

To broaden the range of possible uses, the nonwovens of the present invention may be laminated with other materials, for example nonwovens, textiles, leather, paper.

The present invention accordingly also provides seals in the industrial sector, hygiene products, filters, medical/medicinal products, laminates and textiles, more preferably hygiene products and/or medical/medicinal products comprising the nonwovens of the present invention.

The examples which follow illustrate the invention.

### EXAMPLES

Elastollan® LP 9300 (aliphatic TPU from Elastogran GmbH) and Elastollan® LP 9277 (aliphatic TPU from Elastogran GmbH) were used in Examples 1.1 and 1.2 to produce nonwovens. The two TPUs had the following crystallization temperatures:

### Elastollan® LP 9300: 93.7° C.

### Elastollan® LP 9277: 166° C.

Elastollan® LP 9277 is a hard phase modified aliphatic polyester polyurethane based on butanediol, HDI, polyester diol (2-methylpropanediol, butanediol adipic acid copolyester) of molecular weight 3000 g/mol and having polybutylene terephthalate segment as hard phase.

Elastollan® LP 9300 is an aliphatic TPU based on butanediol adipate polyester diol (molar mass 2400 g/mol), butanediol as chain extender and HDI.

Crystallization temperatures were determined by taking samples from injection-molded test plates 12 cm*8 cm*0.2 cm in size and analyzing them using a DSC apparatus (Perkin Elmer 7) according to the following test program:

1. hold at 25° C. for 0.1 min
2. heat from 25° C. to 10° C. at 40 K/min
3. hold at 100° C. for 10 min
4. cool from 100° C. to −80° C. at 20 K/min
5. hold at −80° C. for 2 min
6. heat from −80° C. to 230° C. at 20 K/min
7. hold at 230° C. for 1 min
8. cool from 230° C. to −80° C. at 20 K/min

The crystallization temperature is here taken to be the maximum of the sample's heat release in the cooling cycle.

### Example 1.1

Elastollan® LP 9300 was processed on a commercial meltblown plant comprising a 1 m spinning manifold (25 holes/inch) and a 100 mm extruder to form a meltbown nonwoven having a basis weight of 50 g/m². The temperature of the spinning pump was 240° C., and the temperature of the die was adjusted to 240° C. The temperature of the hot air was 225° C. The die diameter was 0.4 mm. The TPU was difficult to process, the nonwoven was inhomogeneous and had a plasticky hand.

### Example 1.2

An Elastollan® LP 9277 was processed on the same plant. The temperature of the spinning pump was 240° C., the temperature of the die was 240° C. and the temperature of the hot air was 225° C. The basis weight for the nonwoven was likewise set to 50 g/m². In addition, a nonwoven having a basis weight of 100 g/m² was produced. The TPU was readily processible. The resulting nonwoven was homogeneous and had a textile, pleasant hand.

The two nonwoven samples 1.1 and 1.2 were subsequently analyzed to DIN EN 12127.

(MD): values of nonwoven in machine direction
(CD): values of nonwoven in cross direction

The following breaking extension values were determined 48 h after processing:

Elastollan® LP 9300: breaking extension (MD): 160%
breaking extension (CD): 190%
   Elastollan® LP 9277: breaking extension (MD): 240%
breaking extension (CD): 240%

The breaking extension measurements showed the superior mechanical properties of the nonwoven of the present invention.

### Example 2

Elastollan® C85 A 15 HPM was processed on a commercial meltblown plant comprising a 1 m spinning manifold (25 holes/inch) and a 100 mm extruder to form a meltblown nonwoven having a basis weight of 50 g/m². The temperature of the spinning pump was 230° C., the temperature of the die was adjusted to 235° C. The temperature of the hot air was 225° C. The die diameter was 0.4 mm.

A nonwoven having a basis weight of 100 g/m² was produced. Elastollan® C 85 A 15 HPM is an aromatic TPU from Elastogran GmbH.

### Example 3

Two nonwoven specimens of Example 1.2 (100 g/m²) in Example 2 were exposed to light in accordance with DIN EN ISO 4962. The desired light wavelength was obtained by using an outdoor light filter. The Yellowness Index (YI) was determined as a measure of the degree of discoloration.

The nonwoven of Example 3 shows severe discoloration after just 24 h. The inventive nonwoven is still not discolored after 100 h. This demonstrates the superior lightfastness of inventive nonwovens over nonwovens composed of aromatic TPUs.

| | YI at | YI at | YI at | YI at |
|---|---|---|---|---|
| | exposure | exposure | exposure | exposure |
| | time | time | time | time |
| Product | 0 h | 24 h | 48 h | 96 h |
| LP 9277 | 4.5 | 3.3 | 3.7 | 3.4 |
| (Example 1.2) | | | | |
| C85 A 15 HPM | 3.2 | 57 | | |
| (Example 3) | | | | |

We claim:

1. A nonwoven based on a thermoplastic polyurethane having a crystallization temperature between 130° C. and 220° C. and being based on an aliphatic isocyanate.

2. A nonwoven based on a thermoplastic polyurethane obtainable by reaction of (a) isocyanates with (b1) polyester diols having a melting point of more than 150° C., (b2) polyether diols and/or polyester diols each having a melting point of less than 150° C. and a molecular weight of 501 to 8000 g/mol, and also (c) diols having a molecular weight of 62 g/mol to 500 g/mol.

3. The nonwoven according to claim 2 wherein the molar ratio of said diols (c) having a molecular weight of 62 g/mol to 500 g/mol to component (b2) is in the range from 0.1 to 0.01.

4. A nonwoven based on a thermoplastic polyurethane obtainable by
(i) reacting a thermoplastic polyester with a diol (c) and then
(ii) reacting the reaction product from (i) comprising (b1) polyester diol having a melting point of more than 150° C. and also if appropriate (c) diol together with (b2) polyether diols and/or polyester diols each having a melting point of less than 150° C. and a molecular weight of 501 to 8000 g/mol and also if appropriate further (c) diols having a molecular weight of 62 to 500 g/mol with (a) isocyanate if appropriate in the presence of (d) catalysts and/or (e) auxiliaries.

5. The nonwoven according to any one of claims 1 to 4 wherein the thermoplastic polyurethane has a hardness between 50 Shore A and 80 Shore D.

6. The nonwoven according to any one of claims 1 to 4 that has an ISO 9073-1 mass per unit area in the range from 5 to 500 g/m².

7. The nonwoven according to any one of claims 1 to 4 that has an ISO 9073-2 thickness in the range from 0.01 to 5 millimeters (mm).

8. Seals in the industrial sector, hygiene products, filters, medical/medicinal products, laminates and/or textiles comprising nonwoven according to any one of claims 1 to 7.

9. A process for producing nonwoven according to any one of claims 1 to 7, which comprises processing a thermoplastic polyurethane having a crystallization temperature between 130° C. and 220° C. by the meltblown process to form the nonwoven.

10. A process for producing nonwoven according to any one of claims 1 to 7, which comprises processing a thermoplastic polyurethane having a crystallization temperature between 130° C. and 220° C. by the spunbond process to form the nonwoven.
